(19) United States
(12) Patent Application Publication
(10) Pub. No.: US 2024/0121848 A1
(43) Pub. Date: Apr. 11, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/372,813

(22) Filed: Sep. 26, 2023

(30) Foreign Application Priority Data
Oct. 5, 2022 (CN) 202211218370.3

(51) Int. Cl. H04W 76/19; H04W 24/08

(52) U.S. Cl. CPC H04W 76/19; H04W 24/08

(57) ABSTRACT

A method and device for wireless communications, comprising receiving a first signaling; the first signaling comprising a first cell identity, the first cell identity being configured to a target Special Cell (SpCell); detecting a first event; herein, the first event belongs to a first candidate event set, the first candidate event set comprises at least one of a first timer being expired, receiving an indication of MAC of an MCG related to a problem occurring in random access procedure, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling procedure. The present application can achieve better mobility management through a first signaling.

### CROSS REFERENCE TO RELATED APPLICATIONS

This application claims the priority benefit of Chinese Patent Application No. 202211218370.3, filed Oct. 5, 2022, the full disclosure of which is incorporated herein by reference.

### BACKGROUND

### Technical Field

The present application relates to transmission methods and devices in wireless communication systems, and in particular to mobility management for reducing delay, thus avoiding communication interruptions.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

The concepts, terms, and abbreviations used in the present application can refer to the 3GPP standard, including but not limited to:

https://www.3gpp.org/ftp/Specs/archive/21_series/21.905/21905-h10.zip

https://www.3gpp.org/ftp/Specs/archive/38_series/38.300/38300-h10.zip

https://www.3gpp.org/ftp/Specs/archive/38_series/38.331/38331-h10.zip

https://www.3gpp.org/ftp/Specs/archive/38_series/38.321/38321-h10.zip

https://www.3gpp.org/ftp/Specs/archive/38_series/38.304/38304-h10.zip

### SUMMARY

In a latest 3GPP research topic, mobility management is a very important content. In traditional cell handover, the method based on Layer 3, that is, an RRC signaling, is adopted. The terminal reports the L3 measurement result, the network selects an appropriate target cell based on the measurement result, transmits an RRC signaling used to indicate switching to a target cell, and the terminal executes an RRC signaling used for switching. The execution process generally comprises determining a target cell, applying a configuration of the target cell, synchronizing with the target cell, initiating a random access and transmitting a message indicating a completion of the switching. The whole switching process involves: the interpretation and execution of the signaling, downlink synchronization, uplink synchronization, and completion of the remaining switching steps, which generally take several tens of milliseconds to one or two hundred milliseconds. Services that are more sensitive to delay requirements are more affected, with some services exceeding 20 milliseconds causing a noticeable degradation in service quality. Cells become increasingly smaller in 5G with switching becomes increasingly frequent, and the problem of service quality degradation due to switching delay becomes more serious. A possible approach is to use a measurement result from a lower layer, i.e., L1, and to use a signaling from a lower layer, e.g., the physical layer or MAC layer, to indicate switching, in combination with some pre-configured signalings and measures such as pre-synchronization of the terminal, significantly reducing the switching delay. The delay of this switching is relatively short and can be further optimized to reduce the impact of switching on services when executed within a same gNB or within a data unit (DU). In the new switching method, the signaling or message that triggers the switching can be relatively small, so it can be correctly transmitted even when the communication quality is degraded. In the prior art, the user terminal can detect whether radio link failure occurs by some means, and when radio link failure occurs, RRC connection re-establishment is required to restore the connection, however, the RRC connection re-establishment can cause communication interruption and is not the best choice. In particular, when the new switching process described above is in progress, it is inappropriate to interrupt the new switching process for RRC connection re-establishment since the new switching can work even when the channel quality is poor. Therefore, a problem needed to be solved is how to coordinate radio link failure and new switching process to avoid communication interruptions.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. At the same time, the method proposed in the present application can also be used to solve other problems in communications.

The present application provides a method in a first node for wireless communications, comprising: receiving a first signaling; the first signaling comprising a first cell identity, the first cell identity being configured to a target Special Cell (SpCell); and detecting a first event; herein, the first event belongs to a first candidate event set, the first candidate event set comprises at least one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling process; when there is no ongoing first signaling process, the behavior of detecting a first event triggers radio link failure; when there is an ongoing first signaling process, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a Medium Access Control (MAC) layer or control information of a physical layer; the first signaling process comprises at least one of transmitting a first signal, expecting the second signaling, receiving the second signaling, or executing the first signaling; the first signal comprises a measurement result of L 1.

In one embodiment, a problem to be solved in the present application comprises: how to ensure communication reliability, how to reduce switching delay, how to support cell handover triggered by lower layers, how to ensure the continuity of data in the switching process, how to coordinate radio link failure and switching process, how to appropriately determine radio link failure, and how to appropriately initiate an RRC connection re-establishment.

In one embodiment, advantages of the above method comprise: being more flexible, being beneficial for reducing switching delay, ensuring service quality, ensuring service continuity, improving switching reliability, avoiding the impact of data transmission of the switching, and avoiding communication interruption.

Specifically, according to one aspect of the present application, when there is an ongoing first signaling process, the first signaling process failed to be executed successfully is used to trigger an RRC connection re-establishment.

Specifically, according to one aspect of the present application, initiating the first signaling process comprises starting a second timer; a running state of the second timer is used to determine whether there is an ongoing first signaling process; when the second timer is running, there is an ongoing first signaling process; when the second timer is not running, there is no ongoing first signaling process.

Specifically, according to one aspect of the present application, a first indication is received from MAC of an MCG, the first indication is used to indicate that the first signaling process is not successfully executed, and a reception of the first indication is used to trigger radio link failure of an MCG.

Specifically, according to one aspect of the present application, a first condition and whether there is an ongoing first signaling process are used together to determine whether to start a first timer; when there is an ongoing first signaling process, not start the first timer; when there is no ongoing first signaling process and the first condition is met, start the first timer; when there is no ongoing first signaling process and the first condition is not met, not start the first timer; the first condition comprises: receiving N continuous out-of-step indications from lower layer.

Specifically, according to one aspect of the present application, transmit a first report, and the first report is used to indicate whether a first signaling process is successfully executed; the first report comprises an identity of at least the target SpCell.

Specifically, according to one aspect of the present application, initiate an RRC connection re-establishment; the behavior of initiating an RRC re-establishment comprises executing cell selection; as a response to selecting the target SpCell, execute the first signaling.

Specifically, according to one aspect of the present application, the first signal is used to trigger the second signaling.

Specifically, according to one aspect of the present application, transmit a second report, and the second report is used to indicate that the first event is detected; herein, there is an ongoing first signaling process.

Specifically, according to one aspect of the present application, the first node is an IoT terminal.

Specifically, according to one aspect of the present application, the first node is a UE.

Specifically, according to one aspect of the present application, the first node is a relay.

Specifically, according to one aspect of the present application, the first node is an access network device.

Specifically, according to one aspect of the present application, the first node is a vehicle terminal.

Specifically, according to one aspect of the present application, the first node is an aircraft.

Specifically, according to one aspect of the present application, the first node is a mobile phone.

The present application provides a first node for wireless communications, comprising: a first receiver, receiving a first signaling; the first signaling comprising a first cell identity, the first cell identity being configured to a target SpCell; and the first receiver, detecting a first event; herein, the first event belongs to a first candidate event set, the first candidate event set comprises at least one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling process; when there is no ongoing first signaling process, the behavior of detecting a first event triggers radio link failure; when there is an ongoing first signaling process, the behavior of detecting a first event does not trigger radio link failure; the first signaling is a Radio Resource Control (RRC) layer signaling; the first signaling comprises a first field; the first field is used to configure the target Sp Cell; an execution of the first signaling depends on a second signaling; the second signaling is a control signaling of a Medium Access Control (MAC) layer or control information of a physical layer; the first signaling process comprises at least one of transmitting a first signal, expecting the second signaling, receiving the second signaling, or executing the first signaling; the first signal comprises a measurement result of L 1.

In one embodiment, the present application has the following advantages over conventional schemes:

it can support rapid switching process within a same data unit (DU).

it reduces switching latency.

it can ensure the continuity of data during the switching process.

it minimizes the impact of switching on data transmission.

it supports L1 L2 mobility management.

it avoids communication interruption.

it reduces the impact of radio link failure on communications.

it supports rapid recovery during radio link failure.

it helps optimize the network.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling and detecting a first event according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of a signaling format according to one embodiment of the present application;

FIG. 7 illustrates a schematic diagram of a second signaling being used to execute a first signaling according to one embodiment of the present application;

FIG. 8 illustrates a schematic diagram of a first signaling being used to configure a first signal according to one embodiment of the present application;

FIG. 9 illustrates a schematic diagram of a first signal being used to report a measurement result or a recommended target cell or recommended reference signal resources according to one embodiment of the present application;

FIG. 10 illustrates a schematic diagram of a first report being used to indicate whether a first signaling process is successfully executed according to one embodiment of the present application;

FIG. 11 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of receiving a first signaling and detecting a first event according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first signaling in step 101; detects a first event in step 102; herein, the first signaling comprises a first cell identity, the first cell identity is configured to a target SpCell; the first event belongs to a first candidate event set, the first candidate event set comprises at least one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling process; when there is no ongoing first signaling process, the behavior of detecting a first event triggers radio link failure; when there is an ongoing first signaling process, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a Medium Access Control (MAC) layer or control information of a physical layer; the first signaling process comprises at least one of transmitting a first signal, expecting the second signaling, receiving the second signaling, or executing the first signaling; the first signal comprises a measurement result of L 1.

In one embodiment, the first node is a User Equipment (UE).

In one embodiment, the first node is in RRC_CONNECTED state.

In one embodiment, the present application is for NR.

In one embodiment, the present application is for wireless communication networks after NR.

In one embodiment, a serving cell refers to a cell where a UE resides; executing a cell search comprises: a UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in RRC_IDLE state or RRC_INACTIVE state: enabling the UE to receive a system message from the PLMN or the SNPN; after registration, if the UE wishes to establish an RRC connection or continue a suspended RRC connection, the UE can achieve this by executing an initial access on a control channel of residing camping cell; the network may page the UE; so that the UE can receive notifications of Earthquake and Tsunami Warning System (ETWS) and Commercial Mobile Alert System (CMAS).

In one embodiment, for a UE in RRC_CONNECTED state that is not configured with carrier aggregation/dual connectivity (CA/DC), only one serving cell comprises a PCell; if a UE is only connected to one cell, then this cell is a main cell of UE. For a UE in RRC_CONNECTED state that is configured with CA/DC, a serving cell is used to indicate a cell set comprising a Special Cell (SpCell) and all sub-cells. The PCell is a cell in a Master Cell Group (MCG), which works at primary frequency, and the UE executes an initial connection establishment procedure or initiates a connection re-establishment on the PCell. For a dual connectivity operation, there can also be a Secondary Cell Group (SCG), where an SpCell refers to a PCell of an MCG or a Primary SCG Cell (PSCell) of an SCG; if it is not a dual connectivity operation, an SpCell refers to a PCell.

In one embodiment, a frequency at which a Secondary Cell (SCell) operates is a sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in an MR-DC, a radio access node providing a control-plane connection to the core network is a master node, the master node may be a master eNB, a master ng-eNB, or a master gNB.

In one embodiment, an MCG refers to, in MR-DC, a group of serving cells associated with a master node, comprising an SpCell, and optionally one or multiple SCells.

In one embodiment, a PCell is an SpCell of an MCG.

In one embodiment, a PSCell is an SpCell of an SCG.

In one embodiment, in an MR-DC, a control plane connection to the core network is not provided, and a radio access node providing extra resources to the UE is a sub-node. The sub-node can be an en-gNB, a sub-ng-eNB or a sub-gNB.

In one embodiment, in an MR-DC, a group of serving cells associated with a sub-node is a Secondary Cell Group (SCG), comprising an SpCell and, optionally, one or multiple SCells.

In one embodiment, the target signaling is an RRC message.

In one embodiment, the first signaling is or comprises at least partial fields of an RRC message.

In one embodiment, the first signaling is or comprises a field of an RRC message.

In one embodiment, content of a field in the present application is a cell, and comprising a field means comprising the cell.

In one embodiment, content of a field in the present application is multiple cells, and comprising a field means comprising the multiple cells.

In one embodiment, the first signaling is an RRCReconfiguration message.

In one embodiment, the first signaling comprises partial fields in an RRCReconfiguration message.

In one embodiment, the first signaling only comprises partial fields in an RRCReconfiguration message.

In one embodiment, each RRCReconfiguration comprises at least one CellGroupConfig.

In one embodiment, the first signaling is or comprises a CellGroupConfig field or a corresponding cell.

In one embodiment, the first signaling is CellGroupConfig for a cell group of the target SpCell.

In one embodiment, each CellGroupConfig comprises at least one SpCellConfig.

In one embodiment, the first field is spCellConfig.

In one embodiment, the first signaling comprises one or more CellGroupConfig fields in an RRCReconfiguration message.

In one embodiment, the first signaling is or comprises a SpCellConfig field or a corresponding cell.

In one embodiment, the first signaling is a SpCellConfig for the target SpCell.

In one embodiment, the first signaling comprises one or multiple SpCellConfig fields in an RRCReconfiguration message.

In one embodiment, the first signaling comprises one or multiple SpCellConfig fields in a CellGroupConfig message.

In one embodiment, when an execution of the first signaling does not depend on receiving the second signaling, the first signaling is an RRCReconfiguration message.

In one embodiment, when an execution of the first signaling does not depend on receiving the second signaling, the first signaling only comprises a SpCellConfig.

In one embodiment, when an execution of the first signaling depends on the second signaling, the first signaling can comprise multiple CellGroupConfig fields, and each CellGroupConfig field is used to configure an MCG.

In one embodiment, when an execution of the first signaling depends on the second signaling, the first signaling can comprise multiple SpCellConfig fields, and each SpCellConfig field is used to configure a PCell.

In one embodiment, the first signaling is transmitted to the first node by unicast.

In one embodiment, a logical channel occupied by the first signaling comprises a downlink control channel (DCCH).

In one embodiment, the SpCell comprises at least one of a PCell and a PSCell.

In one embodiment, the SpCell is a PCell.

In one embodiment, the SpCell is a PSCell.

In one embodiment, the target SpCell specifically refers to a target cell in cell handover.

In one embodiment, the first cell identity is a Physical Cell Identity (PCI).

In one embodiment, a physCellId field in the first signaling indicates the first cell identity.

In one embodiment, the meaning of the phrase that the first cell identity is configured to a target SpCell comprises: the target SpCell is a cell indicated by the first cell identity searched on specific time-frequency resources.

In one embodiment, the meaning of the phrase that the first cell identity is configured to a target SpCell comprises: when the first signaling indicates downlink frequency information, the target SpCell is a cell indicated by the first cell identity on synchronization signal block (SSB) frequency indicated by the downlink frequency information.

In one embodiment, the meaning of the phrase that the first cell identity is configured to a target SpCell comprises: when the first signaling does not indicate downlink frequency information, the target SpCell is a cell indicated by the first cell identity on SSB frequency of a source cell of the first node.

In one embodiment, the meaning of the phrase that the first cell identity is configured to a target SpCell comprises: a cell determined by the first cell identity is the target SpCell.

In one embodiment, the target SpCell corresponds to a source cell or a source SpCell.

In one embodiment, the source cell or source SpCell is a cell in which the first node receives the first signaling.

In one embodiment, the source cell or source SpCell is a cell before the switching of the first node.

In one embodiment, the first cell identity is or comprises a cell index.

In one embodiment, the first cell identity is or comprises an NR Cell Global Identity (NCGI).

In one embodiment, after an execution of the first signaling is completed, the target SpCell becomes an SpCell of the first node.

In one embodiment, an execution of the first signaling depends on the second signaling.

In one embodiment, when the first timer is not running, an execution of the first signaling depends on the second signaling.

In one embodiment, at least when the first timer is not running, an execution of the first signaling depends on the second signaling.

In one embodiment, when an RRC connection re-establishment is not initiated, an execution of the first signaling depends on the second signaling.

In one embodiment, when there is no ongoing RRC connection re-establishment process, an execution of the first signaling depends on the second signaling.

In one embodiment, the first signaling is not automatically executed after being received.

In one embodiment, the first signaling is not immediately executed after being received.

In one embodiment, an execution of the first signaling needs to be triggered.

In one embodiment, conditions for triggering an execution of the first signaling comprise receiving a second signaling.

In one embodiment, conditions for triggering an execution of the first signaling comprise receiving a second signaling when the first timer is not running.

In one embodiment, conditions for triggering an execution of the first signaling comprise receiving a second signaling when the first timer is running. In one embodiment, conditions for triggering an execution of the first signaling comprise that a selected cell during RRC connection re-establishment is the target SpCell.

In one embodiment, conditions for triggering an execution of the first signaling comprise that a selected cell when the first timer is running is the target SpCell.

In one embodiment, when the first timer is running, the second signaling triggers the first signaling.

In one embodiment, when the first timer is running and a selected cell is the target SpCell, the first signaling is executed.

In one embodiment, when the first timer is running and a selected cell is not the target SpCell, the first signaling is not executed.

In one embodiment, when an RRC re-establishment process is initiated and a selected cell is the target SpCell, the first signaling is executed.

In one embodiment, when an RRC re-establishment process is initiated and a selected cell is not the target SpCell, the first signaling is not executed.

In one embodiment, when there is an ongoing RRC re-establishment process and a selected cell is not the target SpCell, the first signaling is not executed.

In one embodiment, when an execution of the first signaling does not depend on receiving the second signaling, the first signaling is immediately executed after being received.

In one embodiment, when an execution of the first signaling does not depend on receiving the second signaling, the first signaling is executed after being received and a measurement event associated with the first signaling is satisfied.

In one embodiment, the meaning that an execution of the first signaling does not depend on receiving second signaling is: whether the second signaling is received or not does not affect an execution of the first signaling.

In one embodiment, the meaning that an execution of the first signaling does not depend on receiving second signaling is: the first signaling can also be executed without receiving the second signaling.

In one embodiment, the meaning of the phrase that an execution of the first signaling depends on a second signaling is: the first signaling can be executed only after receiving the second signaling.

In one embodiment, the meaning of the phrase that an execution of the first signaling depends on a second signaling is: if the second signaling is not received, the first signaling is not executed.

In one embodiment, the meaning of the phrase that an execution of the first signaling depends on a second signaling is: the first signaling is saved first after being received, and the first signaling can be executed after the second signaling is received.

In one embodiment, the meaning of the phrase that the first signaling is a signaling of an RRC layer is: the first signaling is generated at the RRC layer.

In one embodiment, the meaning of the phrase that the first signaling is a signaling of an RRC layer is: the first signaling is an RRC signaling.

In one embodiment, the meaning of the phrase that the first signaling is a signaling of an RRC layer is: the first signaling is one or multiple fields in an RRC signaling.

In one embodiment, the meaning of the phrase that the first signaling is a signaling of an RRC layer is: the first signaling is one or multiple RRC cells.

In one embodiment, the first signaling comprises at least the first field.

In one embodiment, the first field of the first signaling is configured with a cell identity of the target SpCell.

In one embodiment, the first field of the first signaling comprises the first cell identity.

In one embodiment, the first field of the first signaling is configured with downlink frequency information of the target SpCell.

In one embodiment, the first field of the first signaling is configured with uplink access information of the target SpCell.

In one embodiment, the first field of the first signaling is configured with uplink resources of the target SpCell.

In one embodiment, the first field of the first signaling is configured with a bandwidth part (BWP) of the target SpCell.

In one embodiment, the first field of the first signaling is configured with power of the target SpCell.

In one embodiment, the first field of the first signaling is configured with a timing advance of the target SpCell.

In one embodiment, the first field of the first signaling is configured with a reference signal of the target SpCell.

In one embodiment, the first field of the first signaling is configured with a control channel of the target SpCell.

In one embodiment, the first field of the first signaling is configured with a spatial parameter of the target SpCell.

In one embodiment, the second signaling is MAC Control Element (CE).

In one embodiment, the second signaling is Downlink control information (DCI).

In one embodiment, the second signaling is below an RRC layer.

In one embodiment, the second signaling is a signaling of MAC layer or physical layer.

In one embodiment, the second signaling explicitly indicates whether to execute the first signaling.

In one embodiment, the second signaling comprises a configuration identity or configuration index of the first signaling.

In one embodiment, when the second signaling comprises a configuration identity or configuration index of the first signaling, triggering the first signaling is executed.

In one embodiment, the second signaling indicates the target SpCell.

In one embodiment, when the second signaling indicates the target SpCell, the first signaling is executed.

In one embodiment, the second signaling indicates resources or a reference signal of the target SpCell.

In one embodiment, when the second signaling indicates resources or a reference signal of the target SpCell, triggering the first signaling is executed.

In one embodiment, before receiving the second signaling, the first node transmits a first signal.

In one embodiment, the first signal is transmitted after receiving the first signaling.

In one embodiment, the second signaling is received after transmitting the first signal.

In one embodiment, the first signal is used to trigger the second signaling.

In one embodiment, the first signal comprises a measurement result.

In one embodiment, the first signal comprises L1 measurement result(s).

In one embodiment, the first signal comprises L1-RSRP.

In one embodiment, the first signal comprises an identity or an index.

In one subembodiment of the embodiment, the identity or index is associated with the first signaling.

In one subembodiment of the embodiment, the identity or index is associated with the target SpCell.

In one embodiment, the second signaling comprises the identity or the index indicated by the first signal.

In one embodiment, when the second signaling comprises the identity or the index indicated by the first signal, an execution of the first signaling associated with the identity or the index is triggered.

In one embodiment, the meaning of the phrase that the second signaling is used to execute the first signaling comprises: the second signaling triggers an execution of the first signaling.

In one embodiment, when an execution of the first signaling does not depend on receiving the second signaling, an execution of the first signaling comprises initiating a random access to the target SpCell.

In one embodiment, when an execution of the first signaling does not depend on receiving the second signaling, an execution of the first signaling triggers initiating a random access to the target SpCell.

In one embodiment, when an execution of the first signaling does not depend on receiving the second signaling, accompanying an execution of the first signaling, the first node initiates a random access to the target SpCell.

In one embodiment, the RRC connection re-establishment comprises transmitting an RRCReestablishmentRequest message.

In one embodiment, the RRC connection re-establishment comprises suspending SRB1.

In one embodiment, the RRC connection re-establishment comprises suspending SRB0 and all RBs other than MBS radio bearer (MRB) for broadcasting.

In one embodiment, the RRC connection re-establishment comprises suspending current services.

In one embodiment, the RRC connection re-establishment comprises releasing an SCG or an SCell.

In one embodiment, the RRC connection re-establishment comprises resetting MAC.

In one embodiment, the RRC connection re-establishment comprises starting T311 timer.

In one embodiment, the RRC connection re-establishment comprises releasing spCellConfig.

In one embodiment, the RRC connection re-establishment comprises releasing or deleting the first signaling.

In one embodiment, the RRC connection re-establishment comprises cell selection.

In one embodiment, initiating an RRC connection re-establishment is for re-establishing an RRC connection.

In one embodiment, the reason for initiating an RRC connection re-establishment comprises: detecting that T316 timer is expired.

In one embodiment, the reason for initiating an RRC connection re-establishment comprises: detecting that radio link failure occurs in an MCG and T316 is not configured.

In one embodiment, the reason for initiating an RRC connection re-establishment comprises: re-configuration with sync of an MCG fails.

In one embodiment, the reason for initiating an RRC connection re-establishment comprises: lower layer indicates that integrity protection verification of signaling radio bearer 1 (SRB1) or SRB2 fails.

In one embodiment, entering into RRC_IDLE state means losing an RRC connection with the access network.

In one embodiment, communications with a serving cell require leaving RRC_IDLE state.

In one embodiment, communications with a serving cell requires an RRC connection.

In one embodiment, the first signaling is transmitted by unicast.

In one embodiment, a logical channel occupied by the first signaling comprises a Dedicated Control Channel (DCCH).

In one embodiment, the first signaling uses encryption.

In one embodiment, the first signaling uses integrity protection.

In one embodiment, the second signaling uses encryption.

In one embodiment, the second signaling uses integrity protection.

In one embodiment, the second signaling does not use encryption.

In one embodiment, the second signaling does not use integrity protection.

In one embodiment, the second signaling is for the first node.

In one embodiment, the second signaling is only for the first node.

In one embodiment, a physical channel occupied by the second signaling comprises a Physical Downlink Control Channel (PDCCH).

In one embodiment, a physical channel occupied by the second signaling comprises a Physical Downlink Shared Channel (PDSCH).

In one embodiment, the meaning of the phrase of as a response to receiving the second signaling, executing the first signaling comprises: the second signaling triggers executing the first signaling.

In one embodiment, the meaning of executing the first signaling is: executing partial fields comprised in the first signaling.

In one embodiment, the meaning of executing the first signaling is: executing all fields comprised in the first signaling.

In one embodiment, the meaning of executing the first signaling is: executing all cells comprised in the first signaling.

In one embodiment, the meaning of executing the first signaling is: executing partial cells comprised in the first signaling.

In one embodiment, the meaning of executing the first signaling is: executing all fields and sub-fields comprised in the first signaling, and so on.

In one embodiment, the meaning of executing the first signaling is: executing the first signaling comprises at least executing reconfigurationWithSync comprised in the first signaling.

In one embodiment, the meaning of executing the first signaling is: executing the first signaling comprises at least executing the first field comprised in the first signaling.

In one embodiment, the higher layer comprises an RRC layer.

In one embodiment, the lower layer comprises a MAC layer.

In one embodiment, the lower layer comprises a physical layer.

In one embodiment, the lower layer comprises a protocol layer below an RRC layer.

In one embodiment, the first field of the first signaling comprises reconfigurationWithSync.

In one embodiment, the first field of the first signaling does not comprise reconfigurationWithSync.

In one embodiment, an execution of the first signaling comprises using a new C-RNTI.

In one embodiment, the new C-RNTI is an identity indicated by a newUE-Identity field.

In one embodiment, an execution of the first signaling comprises configuring a lower layer based on received spCellConfigCommon.

In one embodiment, an execution of the first signaling comprises starting the first timer.

In one embodiment, an execution of the first signaling comprises synchronization of the target SpCell.

In one embodiment, an execution of the first signaling comprises applying a BCCH configuration.

In one embodiment, an execution of the first signaling comprises determining the target SpCell.

In one embodiment, an execution of the first signaling comprises applying a new C-RNTI.

In one embodiment, an execution of the first signaling comprises configuring a lower layer based on received spCellConfigCommon.

In one embodiment, a cell group to which the target SpCell belongs is an MCG.

In one embodiment, a cell group to which the target SpCell belongs is an SCG.

In one embodiment, the first signaling explicitly indicates whether to reset MAC of a cell group of the target SpCell.

In one embodiment, when an execution of the first signaling does not depend on receiving a second signaling, the behavior of executing the first signaling comprises resetting MAC of a cell group of the target SpCell.

In one embodiment, the phrase that when an execution of the first signaling depends on receiving a second signaling, the behavior of executing the first signaling not comprising starting a first timer is established only when an execution of the first signaling does not trigger a random access process.

In one embodiment, when an execution of the first signaling does not depend on receiving a second signaling, an execution of the first signaling triggers a random access process.

In one embodiment, when an execution of the first signaling does not depend on receiving a second signaling, a random access process accompanies an execution of the first signaling.

In one embodiment, when an execution of the first signaling does not depend on receiving a second signaling, an execution of the first signaling involves a random access process.

In one embodiment, when an execution of the first signaling does not depend on receiving a second signaling, an execution of the first signaling comprises a random access process.

In one embodiment, when an execution of the first signaling does not trigger a random access process, and an execution of the first signaling depends on receiving a second signaling, the behavior of executing the first signaling does not comprise starting a first timer.

In one embodiment, when an execution of the first signaling triggers or involves or accompanies a random access process, and an execution of the first signaling depends on receiving a second signaling, the behavior of executing the first signaling comprises starting a first timer.

In one embodiment, when an execution of the first signaling depends on receiving a second signaling, an execution of the first signaling does not trigger a random access process.

In one embodiment, when an execution of the first signaling depends on receiving a second signaling, an execution of the first signaling does not involve a random access process.

In one embodiment, when an execution of the first signaling depends on receiving a second signaling, an execution of the first signaling does not accompany a random access process.

In one embodiment, when an execution of the first signaling depends on receiving a second signaling, an execution of the first signaling does not comprise a random access process.

In one embodiment, when the first signaling is executed, whether a random access process is triggered or involved or accompanied is used to determine whether to start a first timer.

In one embodiment, when the first signaling is executed, a random access process is triggered or involved or accompanied, and an execution of the first signaling comprises starting a first timer.

In one embodiment, when the first signaling is executed, a random access process is not triggered or involved or accompanied, and an execution of the first signaling does not comprise starting a first timer.

In one embodiment, when an execution of the first signaling does not depend on receiving a second signaling, a random access process accompanies an execution of the first signaling.

In one embodiment, when an execution of the first signaling depends on receiving a second signaling, a random access process does not accompany an execution of the first signaling.

In one embodiment, when an execution of the first signaling does not depend on receiving the second signaling, an execution of the first signaling comprises starting a first timer; when an execution of the first signaling depends on the second signaling, an execution of the first signaling does not comprise starting the first timer; an expiration of the first timer is used to trigger an RRC connection re-establishment, and a stopping condition for the first timer comprises a successful completion of a random access process for the target SpCell.

In one embodiment, the RRC connection re-establishment comprises transmitting an RRCReestablishmentRequest message.

In one embodiment, the RRC connection re-establishment comprises suspending SRB1.

In one embodiment, the RRC connection re-establishment comprises suspending SRB0 and all RBs other than MBS radio bearer (MRB) for broadcasting.

In one embodiment, the RRC connection re-establishment comprises suspending current services.

In one embodiment, the RRC connection re-establishment comprises releasing an SCG or an SCell.

In one embodiment, the RRC connection re-establishment comprises resetting MAC.

In one embodiment, the RRC connection re-establishment comprises starting T311 timer.

In one embodiment, the RRC connection re-establishment comprises releasing spCellConfig.

In one embodiment, the RRC connection re-establishment comprises releasing or deleting the first signaling.

In one embodiment, the RRC connection re-establishment comprises cell selection.

In one embodiment, when an execution of the first signaling depends on receiving the second signaling, an execution of the second field comprised in the first signaling does not comprise synchronization with the target SpCell; when an execution of the first signaling does not depend on receiving the second signaling, an execution of the second field comprised in the first signaling comprises synchronization with the target SpCell. In one embodiment, when an execution of the first signaling depends on receiving a second signaling, the process of synchronizing with the target SpCell is executed before executing the first signaling.

In one embodiment, when an execution of the first signaling depends on receiving the second signaling, and when the first signaling is executed, the first node has already synchronized with the target SpCell.

In one embodiment, when an execution of the first signaling depends on receiving the second signaling, an execution of the second field comprised in the first signaling comprises rapid synchronization with the target SpCell; when an execution of the first signaling does not depend on receiving the second signaling, an execution of the second field comprised in the first signaling comprises synchronization with the target SpCell.

In one subembodiment of the embodiment, the rapid synchronization is different from the synchronization.

In one subembodiment of the embodiment, the rapid synchronization comprises pre-synchronization.

In one subembodiment of the embodiment, the rapid synchronization based on the first node have obtained timing for the target SpCell.

In one embodiment, a cell group to which the target SpCell belongs is an MCG.

In one embodiment, a cell group to which the target SpCell belongs is an SCG.

In one embodiment, MAC reset or resetting MAC comprises clearing a Hybrid Automatic Repeat reQuest (HARQ) cache.

In one embodiment, MAC reset or resetting MAC comprises stopping a timer of MAC layer.

In one embodiment, MAC reset or resetting MAC comprises stopping a random access process.

In one embodiment, an execution of the first signaling is for an MCG.

In one embodiment, initiating an RRC connection re-establishment comprises at least performing cell selection.

In one embodiment, the first signaling is used for switching, and the target SpCell is the target cell of the handover.

In one embodiment, when an execution of the first signaling is completed, the target SpCell becomes an SpCell of the first node.

In one embodiment, an execution of the first signaling comprises or requires synchronization with the target SpCell.

In one embodiment, at a completion of an execution of the first signaling, the first node disconnects from a source SpCell.

In one embodiment, an execution of the first signaling comprises stopping the first timer.

In one embodiment, the first signaling process is used for mobility management.

In one embodiment, the first signaling is used for handover.

In one embodiment, the first signal is uplink control information of the physical layer.

In one embodiment, the first signal is control information of the MAC layer.

In one embodiment, the first signal is used to trigger the second signaling.

In one embodiment, the first event is any event in the first event set.

In one embodiment, the first event is a specific event in the first candidate event set.

In one embodiment, the first candidate event set only comprises: the first candidate event set comprises one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure.

In one embodiment, the first candidate event set only comprises: the first candidate event set comprises two of a first timer being expired, receiving an indication of MAC of an MCG related to a problem occurring in random access process, receiving an indication of RLC of an MCG related to reaching a maximum number of retransmissions, and receiving an indication of MAC of an MCG related to continuous uplink LBT failure.

In one embodiment, the first candidate event set only comprises: the first candidate event set comprises three of a first timer being expired, receiving an indication of MAC of an MCG related to a problem occurring in random access process, receiving an indication of RLC of an MCG related to reaching a maximum number of retransmissions, and receiving an indication of MAC of an MCG related to continuous uplink LBT failure.

In one embodiment, the first candidate event set comprises: the first candidate event set comprises all of a first timer being expired, receiving an indication of MAC of an MCG related to a problem occurring in random access process, receiving an indication of RLC of an MCG related to reaching a maximum number of retransmissions, and receiving an indication of MAC of an MCG related to continuous uplink LBT failure.

In one embodiment, the first candidate event set comprises at least: the first candidate event set comprises an expiration of a first timer.

In one embodiment, the first candidate event set comprises at least: receiving an indication of MAC of an MCG related to a problem occurring in random access process.

In one embodiment, the first candidate event set comprises at least: receiving an indication of RLC of an MCG related to reaching a maximum number of retransmissions.

In one embodiment, the first candidate event set comprises at least: receiving an indication of MAC of an MCG related to continuous uplink LBT failure.

In one embodiment, the first event is: receiving an indication of MAC of an MCG related to a problem occurring in random access process.

In one embodiment, the first event is: receiving an indication of MAC of an MCG related to continuous uplink LBT failure.

In one embodiment, the meaning of the phrase of MAC of an MCG is: being from MAC of an MCG of the first node.

In one embodiment, the meaning of the phrase of MAC of an MCG is: being transmitted from MAC of an MCG of the first node.

In one embodiment, the meaning of the phrase of RLC of an MCG is: being from RLC of an MCG of the first node.

In one embodiment, the meaning of the phrase of RLC of an MCG is: being transmitted from RLC of an MCG of the first node.

In one embodiment, the meaning of the phrase of RLC of an MCG is: any RLC of an MCG of the first node.

In one embodiment, the meaning of the phrase of RLC of an MCG is: any acknowledge mode (AM) RLC of an MCG of the first node.

In one embodiment, the meaning of the phrase of RLC of an MCG is: randomly transmitted RLC of an MCG of the first node.

In one embodiment, the meaning of the phrase of receiving an indication of MAC of an MCG related to a problem occurring in random access process is, RRC of the first node receives an indication of MAC of an MCG related to a problem occurring in random access process.

In one embodiment, the meaning of the phrase of receiving an indication of RLC of an MCG related to reaching a maximum number of retransmissions is, RRC of the first node receives an indication of RLC of an MCG related to reaching a maximum number of retransmissions.

In one embodiment, the meaning of the phrase of receiving an indication of MAC of an MCG related to continuous uplink LBT failure is, RRC of the first node receives an indication of MAC of an MCG related to continuous uplink LBT failure.

In one embodiment, the LBT is used for unlicensed spectrum communications.

In one embodiment, the LBT is a communication method for unlicensed spectrum communication.

In one embodiment, a problem occurring in the random access comprises, for example, reaching a maximum number of random access attempts.

In one embodiment, the meaning of an indication of RLC of the MCG related to reaching a maximum number of retransmissions comprises: RLC retransmissions performed by RLC of an MCG reaching a maximum number of retransmissions.

In one embodiment, when the first signal is transmitted, there is an ongoing first signaling process.

In one embodiment, there can be at most one first signaling process for an MCG at the same time.

In one embodiment, when the first signal is transmitted, there is an ongoing first signaling process. In one embodiment, when the first signal is transmitted while the second signaling is not received, there is an ongoing first signaling process.

In one embodiment, when the second signaling is received while the first signaling is not executed, there is an ongoing first signaling process.

In one embodiment, when the second signaling is received while an execution of the first signaling is not completed, there is an ongoing first signaling process.

In one embodiment, when an execution of receiving the first signaling is completed, and there is no signaling with a same name with the first signal being transmitted, there is no ongoing first signaling process.

In one embodiment, after receiving the second signaling, and there is no signaling with a same name with the first signal being transmitted, there is no ongoing first signaling process.

In one embodiment, before the first signal is transmitted, there is no ongoing first signaling process.

In one embodiment, the phrase that an execution of the first signaling depends on a second signaling is only established when RRC connection re-establishment is not initiated.

In one embodiment, the phrase that an execution of the first signaling depends on a second signaling is only established when radio link failure does not occur.

In one embodiment, the meaning of the phrase that an execution of the first signaling depends on a second signaling is that an execution of the first signaling depends on the second signaling when RRC connection re-establishment does not occur.

In one embodiment, the first signaling process comprises at least two of transmitting a first signal, expecting the second signaling, receiving the second signaling, and executing the first signaling.

In one embodiment, the first signaling process comprises at least three of transmitting a first signal, expecting the second signaling, receiving the second signaling, and executing the first signaling.

In one embodiment, when there is an ongoing first signaling process, the first signaling process failed to be executed successfully is used to trigger an RRC connection re-establishment.

In one embodiment, the first signaling procedure not being successfully executed comprises: a timer associated with the first signaling procedure being expired.

In one embodiment, the first signaling procedure not being successfully executed comprises: a counter associated with the first signaling procedure reaching a maximum number of times.

In one embodiment, the first signaling procedure not being successfully executed comprises: failed to execute the first signaling.

In one embodiment, the first signaling procedure not being successfully executed comprises: an execution of the first signaling is unsuccessful.

In one embodiment, the first signaling procedure not being successfully executed comprises: the first signaling compatibility check failed.

In one embodiment, the first signaling procedure not being successfully executed comprises: the second signaling indicates a cell other than the target SpCell, and a cell other than the target SpCell is not configured by the first signaling.

In one embodiment, the first signaling procedure not being successfully executed comprises: the second signaling indicates a cell other than the target SpCell, and not receiving a configuration for a cell other than the target SpCell.

In one embodiment, initiating the first signaling process comprises starting a second timer; a running state of the second timer is used to determine whether there is an ongoing first signaling process; when the second timer is running, there is an ongoing first signaling process; when the second timer is not running, there is no ongoing first signaling process.

In one embodiment, the second timer is a timer other than T304.

In one embodiment, an initiation of the first signaling process comprises starting a second timer.

In one embodiment, the meaning of the phrase that an initiation of the first signaling process comprises starting a second timer comprises: starting the second timer when initiating the first signaling process.

In one embodiment, the meaning of the phrase that an initiation of the first signaling process comprises starting a second timer comprises: accompanying a transmission of the first signal, starting the second timer.

In one embodiment, the meaning of the phrase that an initiation of the first signaling process comprises starting a second timer comprises: a reception of the second signaling triggers a start of the second timer.

In one embodiment, the meaning of the phrase that an initiation of the first signaling process comprises starting a second timer comprises: a reception or transmission in the first signaling process triggers starting the second timer.

In one embodiment, the meaning of the phrase that an initiation of the first signaling process comprises starting a second timer comprises: an execution of a signaling in the first signaling process triggers starting the second timer.

In one embodiment, the meaning of the phrase that an initiation of the first signaling process comprises starting a second timer comprises: an RRC layer of the first node receiving an indication of starting the first signaling process from a lower layer, triggering starting the second timer.

In one embodiment, whether a second event is satisfied is used to determine whether the second timer is started.

In one embodiment, the second event is related to measurement.

In one embodiment, the second event is used to determine that quality of a serving cell is worse than a threshold.

In one embodiment, when the second timer is expired, only when quality of a serving cell is worse than a threshold, an RRC connection re-establishment is initiated.

In one embodiment, when the second timer is expired, only when quality of a PCell is worse than a threshold, an RRC connection re-establishment is initiated.

In one embodiment, when the second timer is expired, only when quality of an MCG is worse than a threshold, an RRC connection re-establishment is initiated.

In one embodiment, an expiration of the second timer is used to trigger radio link failure.

In one embodiment, the second timer is an MAC-layer timer.

In one embodiment, the second timer is an RRC-layer timer.

In one embodiment, the second timer is used for mobility management.

In one embodiment, the second timer is used for switching.

In one embodiment, the second timer is used for L1 L2 mobility.

In one embodiment, a successful completion of the first signaling is used to stop the second timer.

In one embodiment, an expiration of the second timer is used to determine that the first signaling process is not successfully completed.

In one embodiment, an expiration of the second timer triggers an RRC connection re-establishment.

In one embodiment, the second timer is used to determine whether there is an ongoing first signaling process.

In one embodiment, the first signal is used to trigger the second signaling.

In one embodiment, a transmission of the first signal inevitably leads to a transmission of the second signaling.

In one embodiment, a transmission of the second signaling is inevitably due to the first signaling.

In one embodiment, the second signaling is not associated with the first signal.

In one embodiment, the phrase of there existing an ongoing first signaling process comprises: there exist untransmitted signalings belonging to the first signaling process, or there exist unreceived signalings belonging to the first signaling process.

In one embodiment, the second signaling is used to indicate executing the first signaling.

In one embodiment, the first signaling is used to configure the first signal.

In one embodiment, the first signal is used to report a measurement result or a recommended target cell or recommended reference signal resources.

In one embodiment, MAC of an MCG of the first node indicates whether there is an ongoing first signaling process in RRC of the first node.

In one embodiment, MAC of an MCG of the first node indicates to RRC of the first node: initiating a first signaling process.

In one embodiment, MAC of an MCG of the first node indicates to RRC of the first node: completing a first signaling process.

In one embodiment, MAC of an MCG of the first node indicates to RRC of the first node running state of a second timer.

In one embodiment, MAC of an MCG of the first node indicates to RRC of the first node: not completing a first signaling process.

In one embodiment, MAC of an MCG of the first node indicates to RRC of the first node: receiving the second signaling, or executing the first signaling, or the target SpCell.

In one subembodiment of the embodiment, receiving the second signaling is used to determine that the first signaling process is completed.

In one subembodiment of the embodiment, indicating an execution of the first signaling is used to determine a completion of the first signaling process.

In one subembodiment of the embodiment, indicating the target SpCell is used to determine a completion of the first signaling process.

### Embodiment 2

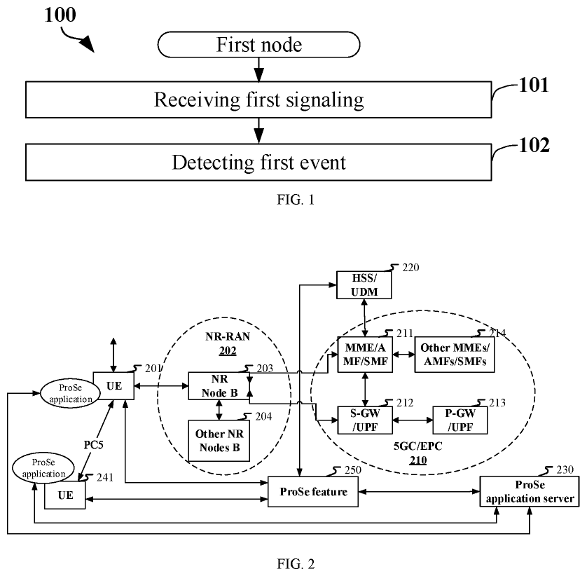

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is a UE 201.

In one embodiment, a base station of the second node in the present application is a gNB 203.

In one embodiment, a radio link between the UE 201 and the NR node B is an uplink.

In one embodiment, a radio link between the NR node B and the UE 201 is a downlink.

In one embodiment, the UE 201 supports relay transmission.

In one embodiment, the UE 201 comprises a mobile phone.

In one embodiment, the UE 201 is a vehicle comprising a car.

In one embodiment, the gNB 203 is a MarcoCellular base station.

In one embodiment, the gNB 203 is a Micro Cell base station.

In one embodiment, the gNB 203 is a Pico Cell base station.

In one embodiment, the gNB 203 is a flight platform.

In one embodiment, the gNB 203 is satellite equipment.

### Embodiment 3

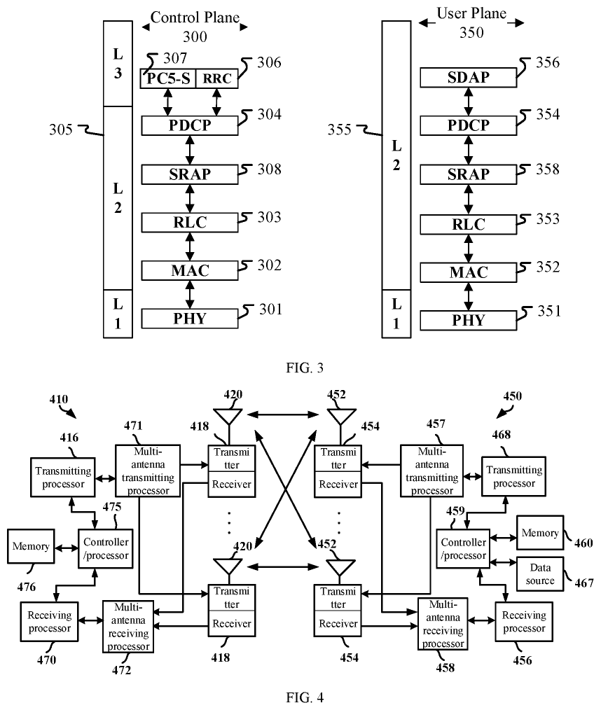

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, and when it comes to sidelink communications, there is also SRB4, which is respectively used to transmit different types of control signalings. SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling. Most of the signalings are transmitted through SRB1. If SRB1 is interrupted or unavailable, the UE must perform RRC re-establishment. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.). For UE involving relay service, its control plane can also comprise the adaptation sub-layer Sidelink Relay Adaptation Protocol (SRAP) 308, and its user plane can also comprise the adaptation sub-layer SRAP 358, the introduction of the adaptation layer helps lower layers, such as MAC layer, RLC layer, to multiplex and/or distinguish data from multiple source UEs. For nodes that do not involve relay communications, PC5-S307, SRAP 308 and SRAP 358 are not required in the communication process.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the second signaling in the present application is generated by the MAC 302 or the PHY 301.

In one embodiment, the first signal in the present application is generated by the MAC 302 or the PHY 301.

In one embodiment, the first report in the present application is generated by the RRC 306.

In one embodiment, the second report in the present application is generated by the RRC 306.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling; the first signaling comprises a first cell identity, the first cell identity is configured to a target SpCell; detects a first event; herein, the first event belongs to a first candidate event set, the first candidate event set comprises at least one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling process; when there is no ongoing first signaling process, the behavior of detecting a first event triggers radio link failure; when there is an ongoing first signaling process, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a Medium Access Control (MAC) layer or control information of a physical layer; the first signaling process comprises at least one of transmitting a first signal, expecting the second signaling, receiving the second signaling, or executing the first signaling; the first signal comprises a measurement result of L1.

In one embodiment, the first communication device 450 comprises at least one processor and at least one memory. a memory that stores a computer readable instruction program. The computer readable instruction program generates an action when executed by at least one processor. The action includes: receiving a first signaling; the first signaling comprising a first cell identity, the first cell identity being configured to a target SpCell; detecting a first event; herein, the first event belongs to a first candidate event set, the first candidate event set comprises at least one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling process; when there is no ongoing first signaling process, the behavior of detecting a first event triggers radio link failure; when there is an ongoing first signaling process, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a Medium Access Control (MAC) layer or control information of a physical layer; the first signaling process comprises at least one of transmitting a first signal, expecting the second signaling, receiving the second signaling, or executing the first signaling; the first signal comprises a measurement result of L 1.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the second signaling in the present application.

In one embodiment, the transmitter 454 (comprising antenna 452), the transmitting processor 468 and the controller/processor 459 are used to transmit the first signal in the present application.

In one embodiment, the transmitter 454 (comprising antenna 452), the transmitting processor 468 and the controller/processor 459 are used to transmit the first report in the present application.

In one embodiment, the transmitter 454 (comprising antenna 452), the transmitting processor 468 and the controller/processor 459 are used to transmit the second report in the present application.

### Embodiment 5

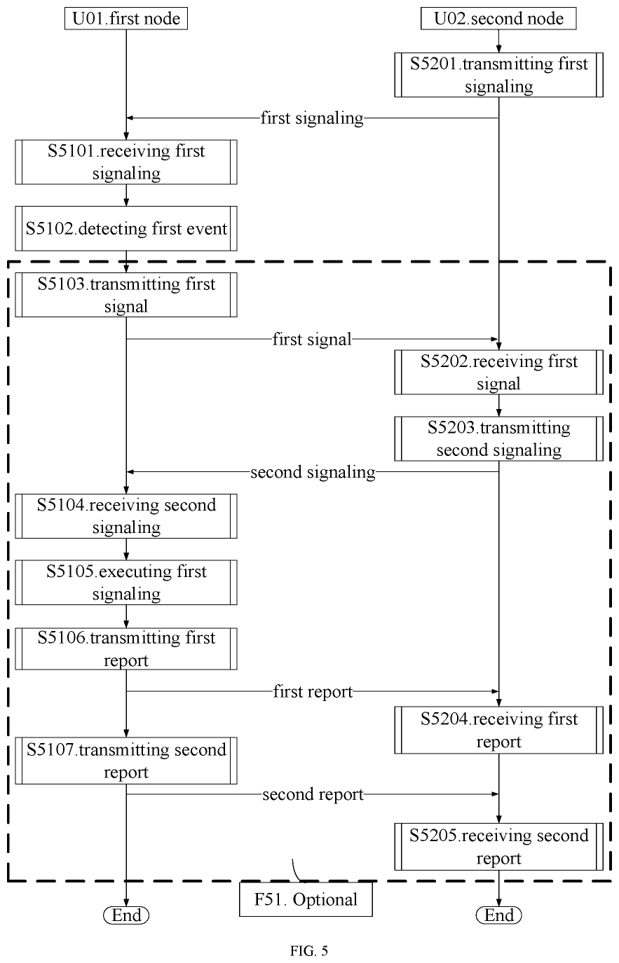

Embodiment 5 illustrates a flowchart of radio signal transmission according to one embodiment in the present application, as shown in FIG. 5. In FIG. 5, U01 corresponds to a first node in the present application, U02 corresponds to a second node in the present application. It is particularly underlined that the order illustrated in the embodiment does not put constraints over sequences of signal transmissions and implementations and steps in F51 are optional.

The first node U01 receives a first signaling in step S5101; detects a first event in step S5102; transmits a first signal in step S5103; receives a second signaling in step S5104; executes a first signaling in step S5105; transmits a first report in step S5106; transmits a second report in step S5107.

The second node U02 transmits a first signaling in step S5201; receives a first signal in step S5202; transmits a second signaling in step S5203; receives a first report in step S5204; receives a second report in step S5205.

In embodiment, the first signaling comprises a first cell identity, the first cell identity is configured to a target SpCell; the first event belongs to a first candidate event set, the first candidate event set comprises at least one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling process; when there is no ongoing first signaling process, the behavior of detecting a first event triggers radio link failure; when there is an ongoing first signaling process, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a Medium Access Control (MAC) layer or control information of a physical layer; the first signaling process comprises at least one of transmitting a first signal, expecting the second signaling, receiving the second signaling, or executing the first signaling; the first signal comprises a measurement result of L1.

In one embodiment, the second node U02 is a base station.

In one embodiment, the second node U02 is a network device.

In one embodiment, the second node U02 is a source cell of the first node U01.

In one embodiment, the second node U02 is a source SpCell of the first node U01.

In one embodiment, the second node U02 is a PCell of the first node U01 when receiving the first signaling.

In one embodiment, the second node U02 is a PSCell of the first node U01 when receiving the first signaling.

In one embodiment, the first node U01 switches from the second node U02 to the target SpCell.

In one embodiment, the first signaling comprises pre-configured parameters used for switching.

In one embodiment, after the first node U01 completes step S5105, a SpCell of the first node U01 is the target SpCell.

In one embodiment, an air interface between the first node U01 and the second node U02 is a Uu interface.

In one embodiment, the first node U01 is in RRC_CONNECTED state.

In one embodiment, the target SpCell is a node other than the second node U02.

In one embodiment, when an execution of the first signaling does not depend on receiving the second signaling, the first node U01 needs to be configured with L3-based measurement and report.

In one subembodiment of the above embodiment, the measurement comprises configuring at least one measObjectNR.

In one subembodiment of the above embodiment, the measurement comprises configuring frequency targeted by measurement.

In one subembodiment of the above embodiment, the measurement comprises configuring a cell targeted by measurement.

In one subembodiment of the above embodiment, the measurement comprises configuring reference signal resources targeted by measurement.

In one subembodiment of the above embodiment, the measurement comprises configuring measurement time targeted by measurement.

In one subembodiment of the above embodiment, the report comprises configuring at least one reportConfig.

In one subembodiment of the above embodiment, each configured measurement comprises a measId, and the measId is associated with a report configuration.

In one subembodiment of the above embodiment, the report comprises configuring a triggering condition for a report, comprising periodic triggering and event triggering.

In one subembodiment of the above embodiment, the report comprises configuring statistics of a report.

In one embodiment, after receiving a report, the second node U02 determines cell handover.

In one embodiment, when an execution of the first signaling depends on the second signaling, the first node U01 may not be configured L3-based measurement and report.

In one subembodiment of the above embodiment, the second node U02 determines cell handover based on the first signal, and the first signal comprises an L1 measurement result or a target cell recommended by L1-based measurement result.

In one embodiment, the meaning of L3-based measurement comprises: using an L3 filter to process measured data.

In one embodiment, the meaning of L1-based measurement comprises: using an L1 filter to process measured data.

In one embodiment, a measurement result of L3 is smoother than a measurement result of L1, but takes longer to acquire.

In one embodiment, the first signaling is used to configure the first signal.

In one embodiment, the step S5101 is taken before the step S5102.

In one embodiment, the step S5101 is taken before the step S5103.

In one embodiment, the step S5104 is taken after the step S5103.

In one embodiment, the step S5105 is taken before the step S5104.

In one embodiment, the step S5201 is taken before the step S5202.

In one embodiment, the step S5203 is taken after the step S5202.

In one embodiment, the first signal is used to trigger the second signaling.

In one embodiment, the meaning that an execution of the first signaling depends on a second signaling comprises: the first signaling is not executed immediately nor automatically upon reception, but rather waits for the second signaling, which is triggered by the second signaling before executing the first signaling.

In one embodiment, the first node U01, as a response to receiving the second signaling, starts a second timer; herein, the second timer is a Medium Access Control (MAC) sublayer timer.

In one embodiment, a stopping condition of the second timer comprises: receiving a fourth signal.

In one subembodiment of the embodiment, the fourth signal is a DCI.

In one subembodiment of the above embodiment, the fourth signal is transmitted by the second node U02.

In one subembodiment of the embodiment, the fourth signal is an ACK.

In one embodiment, the fourth signal is used to confirm that the switching is successful.

In one embodiment, the fourth signal is used to confirm a completion of switching.

In one embodiment, the fourth signal is used to confirm a completion of an execution of the first signaling.

In one embodiment, the fourth signal is used to confirm a completion of an execution of the second signaling.

In one embodiment, a stopping condition of the second timer comprises: completing a random access for the target SpCell.

In one embodiment, a stopping condition of the second timer comprises: an execution of the first signaling being completed.

In one embodiment, an expiration of the second timer is used to determine failure.

In one embodiment, an expiration of the second timer is used to determine failure of cell handover.

In one embodiment, an expiration of the second timer is used to determine failure of an execution of the first signaling.

In one embodiment, an expiration of the second timer is used for an RRC connection re-establishment.

In one embodiment, an expiration of the second timer is used to initiate wave speed failure recovery.

In one embodiment, an expiration of the second timer is used to retransmit information comprised in the first signal.

In one embodiment, an expiration of the second timer is used to execute configuration for an SpCell other than the target SpCell.

In one embodiment, an expiration of the second timer is used to determine that a cell other than the target SpCell is a new target SpCell and execute corresponding configurations.

In one embodiment, an expiration of the second timer is used to trigger falling back to a configuration before an execution of the first signaling.

In one embodiment, an expiration of the second timer is used to fall back to a communication state with the second node U02.

In one embodiment, the first signaling comprises the corresponding configuration.

In one embodiment, a signaling other than the first signaling comprises the corresponding configuration.

In one embodiment, the corresponding configuration comprises spCellConfig at least for the new target SpCell.

In one embodiment, an execution of the corresponding configuration does not depend on receiving a signaling of the second node U02.

In one embodiment, accompanying a transmission of the first signal, start a second timer.

In one embodiment, accompanying a transmission of the first signal, start a third timer.

In one embodiment, before an expiration of the third timer, the first node U01 will no longer transmit a MAC CE with the same name as a MAC CE comprised in the first signal.

In one embodiment, the first node U01 transmits a MAC CE with the same name as a MAC CE comprised in the first signal only after an expiration of the third timer.

In one embodiment, an expiration of the third timer is used to trigger retransmitting information comprised in the first signal.

In one embodiment, an expiration of the third timer is used to trigger transmitting the fifth signal, and the fifth signal has a same MAC CE as the first signal.

In one embodiment, the fifth signal is a retransmission of the first signal.

In one embodiment, the fifth signal is generated at the physical layer.

In one embodiment, the fifth signal is generated at the MAC layer.

In one embodiment, the first signal comprises Uplink control information (UCI).

In one embodiment, a reception of the second signaling is used to stop the third timer.

In one embodiment, an expiration of the third timer is used to determine that a cell other than the target SpCell is a new target SpCell and execute corresponding configurations.

In one subembodiment of the above embodiment, the first signaling comprises the corresponding configuration.

In one subembodiment of the above embodiment, the corresponding configuration comprises at least spCellConfig for the new target SpCell.

In one subembodiment of the above embodiment, an execution of the corresponding configuration does not depend on receiving a signaling from the second node U02.

In one subembodiment of the above embodiment, after executing the corresponding configuration, the first node U01 switches to the new target SpCell.

In one embodiment, the second signaling is a DCI.

In one embodiment, the first node U01 monitors a PDCCH to receive the second signaling.

In one embodiment, the second signaling comprises MAC CE.

In one embodiment, the second signaling is unicast.

In one embodiment, the second signaling indicates reference signal resources of the target SpCell.

In one embodiment, the second signaling indicates beam information of the target SpCell.

In one embodiment, the first signal indicates the recommended reference signal resource of the target SpCell.

In one embodiment, the first signal indicates the recommended beam information of the target SpCell.

In one embodiment, in step S5105, executing a first signaling comprises applying a TCI state.

In one embodiment, in step S5105, executing a first signaling comprises applying a TCI state for the target SpCell.

In one embodiment, in step S5105, executing a first signaling comprises applying a TCI state associated with the target SpCell.

In one embodiment, in step S5105, executing a first signaling comprises applying a unified TCI state.

In one embodiment, after receiving the first signaling, the first node U01 performs feedback confirmation.

In one embodiment, the first signaling is comprised in an RRCReconfiguration message.

In one embodiment, when an execution of the first signaling does not depend on receiving the second signaling, the first node U01 initiates a random access for the target SpCell during an execution of the first signaling or after step S5105.

In one embodiment, the first signaling is used to configure the first signal.

In one embodiment, when an execution of the first signaling does not depend on receiving the second signaling, accompanying an execution of the first signaling, a random access to the target SpCell is initiated; when an execution of the first signaling depends on a second signaling, a first signal is transmitted, accompanying a transmission of the first signal, a random access process is initiated for the target SpCell.

In one embodiment, when an execution of the first signaling depends on the second signaling, an execution of the first signaling does not accompany a random access process for the target SpCell.

In one embodiment, the first signal is transmitted after the first signaling and before the second signaling.

In one embodiment, the first signal is used to report a measurement result or report a recommended target cell or recommended reference signal resources.

In one embodiment, the first signaling comprises a first threshold, the first threshold is used to control a transmission of the first signal.

In one embodiment, the first signaling indicates random access resources for the target SpCell; a random access process for the target SpCell is initiated on random access resources for the target SpCell indicated by the first signaling.

In one embodiment, the first signal is used to trigger the second signal.

In one embodiment, the first node U01, as a response to an expiration of the third timer, reports a failure indication to a higher layer, and the third timer is a timer of a MAC layer.

In one embodiment, the first report comprises an RRC message.

In one embodiment, the first report is used to indicate whether the first signaling process is successfully executed.

In one embodiment, the first report is used to comprise a record of execution failure of the first signaling.

In one embodiment, the first report comprises an identity of at least the target SpCell.

In one embodiment, the second report is used to indicate that the first event is detected.

In one embodiment, the second report is only recorded and/or transmitted when there is an ongoing first signaling process.

In one embodiment, the second report is transmitted when the first signaling process is successfully executed.

In one embodiment, the second report is transmitted during an execution of the first signaling process.

In one embodiment, the second report comprises an RRC message.

In one embodiment, the second report comprises a MAC layer control signaling.

In one embodiment, the second report comprises physical layer control information.

In one embodiment, the second report is a retransmission of the first signal.

In one embodiment, a name of the second report is different from the first signal.

In one embodiment, the second report is used to trigger the second signaling.

In one embodiment, the first signaling is only valid within a first time window.

In one subembodiment of the embodiment, the first signaling indicates the first time window.

In one embodiment, the first signaling process comprises: at least one of step S5103, step S5104, or step S5105.

In one subembodiment, for the first node.

In one embodiment, the first signaling procedure comprises: step S5103 and step S5104.

In one subembodiment, for the first node.

In one embodiment, the first signaling procedure comprises: at least one of step S5103, step S5104, step S5105, step S5202, or step S5203.

In one embodiment, an initiation of the first signaling process comprises the step S5103.

In one embodiment, an end of the first signaling process is receiving the second signaling.

In one embodiment, an end of the first signaling process is executing the first signaling.

In one embodiment, an end of the first signaling process is completing an operation in the first signaling execution.

In one embodiment, an end of the first signaling process is a successful completion of random access to the target SpCell.

In one embodiment, an end of the first signaling process is a successful completion of access to the target SpCell.

In one embodiment, the meaning of the phrase of expecting the second signaling comprises: state and/or time between step S5103 and step S5104.

In one embodiment, the meaning of the phrase of expecting the second signaling comprises: the first signal being used to trigger the second signaling, the first signal having been transmitted but the second signaling having not yet been received.

In one embodiment, the meaning of the phrase of expecting the second signaling comprises: a running period of the third timer.

In one embodiment, a first condition and whether there is an ongoing first signaling process are used together to determine whether to start a first timer.

In one embodiment, when there is an ongoing first signaling process, not start the first timer.

In one embodiment, when there is no ongoing first signaling process and the first condition is met, start the first timer.

In one embodiment, when there is no ongoing first signaling process and the first condition is not met, not start the first timer.

In one embodiment, the first condition comprises: receiving N continuous out-of-step indications from a lower layer.

In one subembodiment of the embodiment, the lower layer comprises a physical layer.

In one subembodiment of the above embodiment, the meaning of N continuous out-of-step indications is: no synchronization indication from a lower layer is received among the N continuous out-of-step indications.

In one subembodiment of the above embodiment, the first signaling is used to indicate the N.

In one subembodiment of the above embodiment, N is a positive integer.

In one subembodiment of the above embodiment, a system information block indicates the N.

In one subembodiment of the above embodiment, N is N310.

In one embodiment, the second timer is a timer other than T304.

In one embodiment, the second report is transmitted through signaling radio bearer 3 (SRB3).

In one embodiment, the second report is transmitted through SRB1.

### Embodiment 6

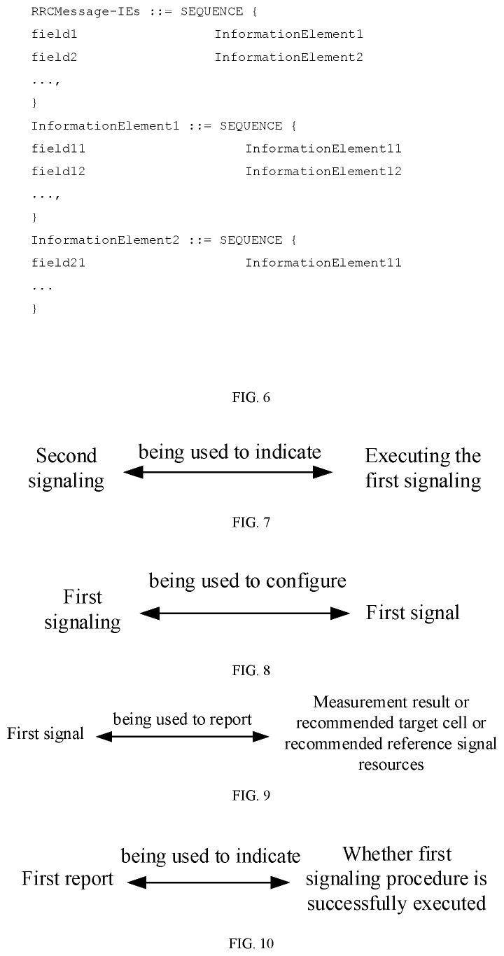

Embodiment 6 illustrates a schematic diagram of a signaling format according to one embodiment of the present application, as shown in FIG. 6.

Field1, field2, field11, field12 and field21 in FIG. 6 are fields.

In one embodiment, a format of an RRC message in the present application is based on the relevant specifications of ISO ASN. 1.

InformationElement1, InformationElement2, InformationElement11, InformationElement12 in FIG. 6 are all RRC IEs.

In one embodiment, an RRC message comprises one or multiple RRC Information Elements (IEs), such as RRCMessage-IEs in FIG. 6.

In one embodiment, RRCMessage-IEs in FIG. 6 is an RRC IE.

In one embodiment, RRCMessage-IEs in FIG. 6 is any IE of an RRC message.

In one embodiment, an RRC IE comprises one or multiple fields, such as field1 and field2 comprised in RRCMessage-IEs in FIG. 6, such as Information.

In one embodiment, fields in FIG. 6 are applicable to the first field in the present application.

In one embodiment, fields in FIG. 6 are applicable to all fields and all RRC signalings in the present application.

In one embodiment, a value of a field in an RRC message can be an RRC IE, such as in FIG. 6, a value of field1 is InformationElement1.

In one embodiment, a field in an RRC message bears or carries an RRC IE, such as in FIG. 6, field1 bears or carries InformationElement1.

In one embodiment, a field in an RRC message corresponds to an RRC IE, such as in FIG. 6, field1 corresponds to InformationElement1.

In one embodiment, in an RRC message, different fields can correspond to or carry or have a value of a same RRC IE, such as both field1l and field21 are set as InformationElement11.

In one embodiment, an IE in an RRC message can comprise one or multiple levels.

In one embodiment, an IE in an RRC message can comprise one or multiple sub-IEs.

In one embodiment, an IE in an RRC message can comprise one or multiple sub-IEs, and/or deeper level IEs.

In one embodiment, an IE in an RRC message can comprise one or multiple subfields and/or grand-fields, such as field1 being a sub-item of RRCMessage-IEs, field1l being a grand-item of an RRCMessage-IE; a subfield of an IE in an RRC message can also comprise its own subfield or grandfield, and so on.

In one embodiment, in the present application, the meaning of a field being reconfigurationWithSync comprises that a name of the field is “reconfigurationWithSync”.

In one embodiment, the first field comprises a subfield ReconfigurationWithSync.

In one embodiment, the first signaling only comprises the first field.

In one subembodiment of the embodiment, the first signaling is spCellConfig.

In one embodiment, the first field is a sub-item of the first signaling.

In one embodiment, the first field is a grand-item of the first signaling.

In one embodiment, the first field is a sub-item of a grand-item of the first signaling.

In one embodiment, the sub-item of an RRC IE is a first level of item comprised in the RRC IE.

In one embodiment, the grand-item of an RRC IE is a second level of item comprised in the RRC IE.

In one embodiment, a sub-item of the grand-item of an RRC IE is a third level of item comprised in the RRC IE.

In one embodiment, whether an execution of the first signaling depends on a second signaling, the first field of the first signaling comprises a second field; the second field is reconfigurationWithSync.

In one embodiment, an execution of any signaling in the present application comprises executing partial fields, or partial sub-fields, and so on, comprised in the any signaling.

In one embodiment, an execution of any signaling in the present application comprises executing all fields comprised in the any signaling.

In one embodiment, the meaning of executing all fields comprised in the any signaling comprises: executing all subfields, grand-fields and so on comprised in the any signaling.

In one embodiment, the meaning of executing all fields comprised in the any signaling comprises: executing a cell corresponding to any field comprised in the any signaling.

In one embodiment, the meaning of executing all fields comprised in the any signaling comprises: executing all cells comprised in the any signaling.

In one embodiment, the any signaling is an RRC signaling.

In one embodiment, an execution of the first signaling comprises executing partial cells or partial sub-cells and so on comprised in the first signaling.

In one embodiment, an execution of the first signaling comprises executing all cells comprised in the first signaling.

In one embodiment, an execution of the first field comprised in the first signaling comprises executing a cell corresponding to the first field of the first signaling.

In one embodiment, the second field comprised in the first field comprised in the first signaling comprises executing a cell corresponding to the second field comprised in the first field of the first signaling.

### Embodiment 7

Embodiment 7 illustrates a schematic diagram of a second signaling indicating executing a first signaling according to one embodiment of the present application, as shown in FIG. 7.

In one embodiment, the second signaling indicates switching to a target SpCell.

In one embodiment, the second signaling indicates executing the first signaling.

In one embodiment, the second signaling comprises an identity or configuration index of the first signaling.

In one embodiment, the second signaling indicates a first reference signal resource, and the first reference signal resource is associated with the target SpCell.

In one embodiment, the second signaling indicates an identity of a cell group to which the target SpCell belongs.

In one embodiment, the second signaling indicates an identity or index of an event or condition, and the identity or index of the event or condition is associated with the first signaling.

In one embodiment, the second signaling indicates an identity or configuration index, and the identity or configuration index is associated with the first signaling.

In one embodiment, the second signaling indicates an identity or configuration index, and the first identity or configuration index is comprised in a first signal.

In one embodiment, the second signaling implicitly indicates the first signaling.

In one embodiment, the second signaling is associated with the first signaling, and upon receiving the second signaling, an execution of the first signaling is indicated.

In one embodiment, a logical channel identity of the second signaling is used to determine an execution of the first signaling.

In one embodiment, a configuration corresponding to a first candidate SpCell indicated by the second signaling belongs to the first signaling, and selecting the first candidate SpCell as a target SpCell triggers an execution of the first signaling.

In one embodiment, the second signaling indicates a first candidate target SpCell and a second candidate target SpCell.

In one embodiment, the first signaling is for the first candidate target SpCell.

In one embodiment, a signaling other than a first signaling, such as a third signaling, is for the second candidate target SpCell.

In one embodiment, the third signaling is an RRC-layer signaling.

In one embodiment, the third signaling comprises partial fields in an RRCReconfiguration message.

In one embodiment, the third signaling comprises CellGroupConfig.

In one embodiment, the third signaling comprises a configuration for the second target SpCell.

In one embodiment, the first node randomly selects the first candidate SpCell or a second candidate SpCell as a target SpCell.

In one embodiment, the first node prioritizes selecting a first candidate SpCell as a target SpCell in the first candidate SpCell or a second candidate SpCell.

In one embodiment, the second signaling is or comprises a field in a DCI.

In one subembodiment of the embodiment, a format of the DCI is one of 0_1, 0_0 and 1_0.

In one subembodiment of the embodiment, a name of a format of the DCI comprises “2_”.

In one subembodiment of the embodiment, a name of a format of the DCI comprises “3_”.

In one subembodiment of the embodiment, a name of a format of the DCI comprises “4_”.

In one subembodiment of the embodiment, a name of a format of the DCI comprises “5_”.

In one embodiment, the first signal is a UCI on a specific physical uplink control channel (PUCCH) resource.

In one subembodiment of the embodiment, the specific PUCCH resource is a PUCCH resource configured for a serving cell of the first node.

In one subembodiment of the embodiment, the specific PUCCH resource is a PUCCH resource used to transmit the first signal configured for a serving cell of the first node.

In one embodiment, the second signaling is a PDCCH command.

In one embodiment, resources indicated by the second signaling are associated with the target SpCell.

In one subembodiment of the embodiment, resources indicated by the second signaling are associated with the first signaling, the second signaling indicating the resources is received, and the first node executes the first signaling.

In one subembodiment of the embodiment, the second signaling indicating the resources is received, and the first node executes the first signaling.

In one embodiment, the first signal indicates the first signaling, and the second signaling is associated with the first signal.

In one subembodiment of the embodiment, upon receiving the second signaling, execute a signaling indicated by the first signal associated with the second signaling, i.e. the first signaling.

In one subembodiment of the embodiment, the second signaling is associated with the first signal through an identity or identifier.

In one subembodiment of the embodiment, the second signaling is associated with the first signal through resources.

In one subembodiment of the embodiment, the second signaling is associated with the first signal through a pre-configured method.

In one subembodiment of the embodiment, the second signaling is associated with the first signal through spatial parameters.

In one subembodiment of the embodiment, the second signaling is associated with the first signal through parameters or identities of a same cell group.

### Embodiment 8

Embodiment 8 illustrates a schematic diagram of a first signaling being used to configure a first signal according to one embodiment of the present application, as shown in FIG. 8.

In one embodiment, the first signaling indicates resources occupied by the first signal.

In one embodiment, the first signaling indicates a maximum number of item(s) comprised in the first signal.

In one embodiment, the first signaling indicates a set of candidate SpCells that can be recommended by the first signal.

In one embodiment, the first signaling indicates reference signal resources targeted by a measurement result comprised in the first signal.

In one embodiment, the first signaling indicates an identity or index of a candidate SpCell recommended by the first signal.

In one embodiment, the first signaling indicates an identity or index of reference signal resources recommended by the first signal.

In one embodiment, the first signaling indicates whether the first signal comprises a recommended candidate SpCell.

In one embodiment, the first signaling indicates whether the first signal comprises an identity or index of recommended reference signal resources.

In one embodiment, the first signaling indicates a triggering condition of a first signal.

In one embodiment, a triggering condition of the first signal comprises: time triggering.

In one embodiment, a triggering condition of the first signal comprises: event triggering.

In one embodiment, a triggering condition of the first signal comprises: when quality of a current serving cell is worse than a first threshold.

In one embodiment, a triggering condition of the first signal comprises: a measurement result of a configured first reference signal resource is less than a first threshold.

In one embodiment, a triggering condition of the first signal comprises: a measurement result of a configured first reference signal resource is less than a first threshold and lasts a certain time.

In one embodiment, a triggering condition of the first signal comprises: a measurement result of a configured first reference signal resource is less than a first threshold, and a measurement result of reference signal resources in a configured second reference signal resource set is greater than a second threshold.

In one embodiment, a triggering condition of the first signal comprises: a measurement result of a configured first reference signal resource is less than a first threshold, and a measurement result of reference signal resources in a configured second reference signal resource set is greater than a second threshold and lasts a certain time.

In one embodiment, a triggering condition of the first signal comprises: a measurement result of a configured first reference signal resource is less than a first threshold, and a measurement result of reference signal resources in a configured second reference signal resource set exceeds a measurement result of the first reference signal resource by at least XdB.

In one embodiment, a triggering condition of the first signal comprises: a measurement result of a configured first reference signal resource is less than a first threshold, and a measurement result of reference signal resources in a configured second reference signal resource set exceeds a measurement result of the first reference signal resource by at least XdB and lasts a certain time.

In one embodiment, the first signaling indicates X, where X is a real number.

In one embodiment, the first signaling indicates the first threshold.

In one embodiment, the first signaling indicates the second threshold.

In one embodiment, the first signaling indicates the certain time.

In one embodiment, the first signaling configures a timer started with a transmission of the first signal.

In one embodiment, the first signaling controls a timer of a transmission of the first signal.

In one embodiment, the first signaling configuration comprises a timer triggered by the first signal.

In one embodiment, the first signaling configuration comprises a timer triggered by the second signaling.

In one embodiment, the first reference signal resource is used for radio link monitoring.

In one embodiment, the first reference signal resource is used for beam failure detection.

In one embodiment, the second reference signal resource set is used for radio link monitoring.

In one embodiment, the second reference signal resource set is used for beam failure detection.

In one embodiment, the second reference signal resource set and reference signal resources used for radio link monitoring are independently configured.

In one embodiment, the second reference signal resource set and reference signal resources used for beam failure detection are independently configured.

In one embodiment, the first reference signal resource and reference signal resources used for radio link monitoring are independently configured.

In one embodiment, the first reference signal resource and reference signal resources used for beam failure detection are independently configured.

In one embodiment, the first signaling indicates whether a selection of other candidate SpCells is allowed after failing to execute the first signaling.

In one embodiment, the first signaling indicates whether not executing an RRC connection re-establishment is allowed.

In one embodiment, the first signaling indicates whether not immediately executing an RRC connection re-establishment is allowed.

In one embodiment, the first signaling indicates whether executing a conditional handover (CHO) evaluation is allowed after transmitting the first signal.

In one embodiment, the first signaling indicates whether executing a CHO evaluation is allowed after receiving the second signaling.

In one embodiment, the first signaling indicates whether executing a conditional PSCell Change (CPC) evaluation is allowed after transmitting the first signal.

In one embodiment, the first signaling indicates whether executing a CPC evaluation is allowed after receiving the second signaling.

In one embodiment, the first signaling indicates whether a recovery process based on the first signaling is supported.

In one embodiment, the first signaling indicates whether a recovery process of signaling execution trigged based on a signaling is supported.

In one embodiment, the first signaling indicates whether a recovery process based on L1L2 mobility is supported.

In one embodiment, the first signaling indicates timing assistance information of the target SpCell.

In one embodiment, the second signaling indicates timing assistance information of the target SpCell.

In one embodiment, when an execution of the first signaling depends on the second signaling, the first signaling does not comprise uplink random access resources for the target SpCell; when an execution of the first signaling does not depend on the second signaling, the first signaling comprises uplink random access resources for the target SpCell.

In one embodiment, when an execution of the first signaling depends on the second signaling, an execution of the first signaling does not stop an evaluation for radio link failure.

In one embodiment, the first signal comprises an identity or index of a reference signal in the second reference signal set.

In one embodiment, the first signal does not comprise an identity or index of the target SpCell.

In one embodiment, a size of the first signal is 0.

In one embodiment, a size of the first signal is greater than 0.

In one embodiment, a priority of the first signal is one of the highest priorities in a MAC CE.

In one embodiment, the first signal only comprises a MAC subheader.

In one embodiment, the first signaling being used to configure the first measurement report comprises: configuring a transmission time of the first measurement report.

In one embodiment, the first signaling being used to configure the first measurement report comprises: configuring a measurement quantity of the first measurement report, such as RSRP.

In one embodiment, the first signaling being used to configure the first measurement report comprises: configuring precision of the first measurement report.

In one embodiment, the first signaling being used to configure the first measurement report comprises: configuring a cell targeted by the first measurement report.

In one embodiment, the first signaling being used to configure the first measurement report comprises: configuring reference signal resources targeted by the first measurement report.

In one embodiment, the first signaling being used to configure the first measurement report comprises: configuring an identity targeted by the first measurement report.

In one embodiment, the first signaling being used to configure the first measurement report comprises: configuring a time to trigger (TTT) of the first measurement report.

In one embodiment, the first measurement report does not correspond to any measurement object.

In one embodiment, the first measurement report comprises L1-RSRP.

### Embodiment 9

Embodiment 9 illustrates a schematic diagram of a first signal being used to report a measurement result or a recommended target cell or recommended reference signal resources according to one embodiment of the present application, as shown in FIG. 9.

In one embodiment, the first signal comprises a measurement result.

In one embodiment, a serving cell of the first node is configured with a first measurement.

In one embodiment, the first measurement is an L1 measurement.

In one embodiment, the first measurement is a measurement for a first reference signal resource set.

In one embodiment, a serving cell of the first node configures the first measurement through the first signaling.

In one embodiment, the first measurement comprises measuring RSRP of L1.

In one embodiment, the first measurement comprises acquiring channel state information.

In one embodiment, the first signal reports a result of the first measurement.

In one embodiment, the first signal is transmitted only when the first measurement is completed.

In one embodiment, the first measurement is periodic.

In one embodiment, the first signal is also periodically transmitted.

In one embodiment, when a triggering condition is satisfied, the first signal is also periodically transmitted.

In one embodiment, the triggering condition comprises that quality of a current cell is worse than a given threshold.

In one embodiment, the triggering condition comprises that quality of a target cell is greater than another given threshold.

In one embodiment, the first measurement result comprises a measurement for multiple cells.

In one embodiment, the first measurement is for a PCI of multiple cells.

In one embodiment, the first signal comprises a recommended target cell.

In one embodiment, the first signal indicates an identity of a target cell or an index of a target cell.

In one subembodiment of the above embodiment, the first signal does not comprise a measurement result.

In one subembodiment of the embodiment, the index of the target cell is an index in a configuration of the first measurement.

In one subembodiment of the embodiment, the index of the target cell is an index indicated by the first signaling.

In one subembodiment of the embodiment, an index of the target cell in the first signal is the same as an index in a configuration of the first measurement.

In one embodiment, the first node determines a recommended target cell based on a result of the first measurement.

In one embodiment, the first node determines a recommended target cell based on parameters of a condition or criteria configured by the first signaling.

In one embodiment, the first node determines a recommended target cell based on S criterion.

In one embodiment, the first node determines a recommended target cell based on internal algorithm.

In one embodiment, the first signal indicates multiple recommended target cells.

In one embodiment, the target SpCell is one of the multiple target cells.

In one embodiment, the target SpCell is a target cell indicated by the first signal.

In one embodiment, the recommended reference signal resource corresponds to a reference signal.

In one embodiment, the first signal comprises an index or identity of recommended reference signal resources.

In one embodiment, recommended reference signal resources comprised the first signal comprise CSI-RS resources.

In one embodiment, recommended reference signal resources comprised the first signal comprise SSB resources.

In one embodiment, recommended reference signal resources comprised the first signal belong to the first reference signal resource set.

In one embodiment, an index of recommended reference signal resources comprised the first signal is an index of the recommended reference signal resources in the first reference signal resource set.

In one embodiment, each reference signal resource in the first reference signal resource set is associated with a cell identity.

In one embodiment, each reference signal resource in the first reference signal resource set maps with a cell identity.

In one embodiment, the first signal indicates a recommended target cell by indicating an identity or index of a measurement configuration.

In one embodiment, the first signal indicates recommended reference signal resources by indicating an identity or index of a measurement configuration.

In one embodiment, the first signal implicitly indicates the recommended target cell.

In one embodiment, the first signal implicitly indicates the recommended reference signal resources.

In one embodiment, the first signal can be used for beam failure recovery.

In one embodiment, a name of a MAC CE comprised in the second signaling comprises L1L2.

In one embodiment, a name of a MAC CE comprised in the second signaling comprises L2.

In one embodiment, a name of a MAC CE comprised in the second signaling comprises Mobility.

In one embodiment, a name of a MAC CE comprised in the first signal comprises L1L2.

In one embodiment, a name of a MAC CE comprised in the first signal comprises L2.

In one embodiment, a name of a MAC CE comprised in the first signal comprises Mobility.

In one embodiment, a name of a MAC CE comprised in the first signal comprises BFR.

In one embodiment, the first signal may comprise both a target cell for a PCell and a target cell for a PSCell.

In one embodiment, the first signal can only comprise either a target cell for a PCell or a target cell for a PSCell.

In one embodiment, a recommended target cell or multiple target cells indicated by the first signal is candidate target cells.

In one embodiment, the first signal comprises a first indication field, and the first indication field is used to indicate whether the recommended target cell is a target cell for a PCell or a target cell for a PSCell. In one subembodiment of the above embodiment, the first indication field occupies a bit.

In one embodiment, the first signal can simultaneously indicate a recommended candidate cell and recommended reference signal resources.

In one embodiment, the recommended reference signal resources are also a recommended reference signal.

In one embodiment, one of the first signal and the second signaling is a DCI and another one is a MAC CE.

In one embodiment, both the first signal and the second signaling are MAC CEs.

In one embodiment, the first signaling indicates that random access resources for the target SpCell are valid within a first window.

In one embodiment, accompanying a transmission of the first signal, the first node starts a third timer.

In one embodiment, before an expiration of the third timer, an execution of the first signaling does not involve or accompany a random access process.

In one embodiment, after an expiration of the third timer, accompanying an execution of the first signaling, the first node initiates a random access for the target cell.

In one embodiment, as a response to receiving the second signaling, the first node stops transmitting a signal used for reporting a measurement result or a recommended target cell or recommended reference signal resources.

In one subembodiment of the above embodiment, the stopping a transmission refers to stopping a transmission during a running time of the second timer.

In one embodiment, as a response to receiving the second signaling, the first node stops transmitting a MAC CE with the same name as a MAC CE comprised in the first signal.

In one subembodiment of the above embodiment, the stopping a transmission refers to stopping a transmission during a running time of the second timer.

In one embodiment, as a response to receiving the second signaling, the first node stops transmitting a MAC PDU the same as a logical channel used by the first signal.

In one subembodiment of the above embodiment, the stopping a transmission refers to stopping a transmission during a running time of the second timer.

In one embodiment, as a response to receiving the second signaling, the first node stops transmitting a retransmission or a copy of the first signal.

In one subembodiment of the above embodiment, the stopping a transmission refers to stopping a transmission during a running time of the second timer.

In one embodiment, as a response to receiving the second signaling, the first node cancels triggered L1 measurement result reporting process.

In one embodiment, as a response to receiving the second signaling, the first node cancels a recommended cell or a recommended reference signal resource reporting process.

In one embodiment, the first signal recommends both a target cell and reference signal resources.

In one embodiment, a name of the first signal comprises mobility.

In one embodiment, a name of the first signal comprises L2.

In one embodiment, a name of the second signaling comprises mobility.

In one embodiment, a name of the second signaling comprises L2.

### Embodiment 10

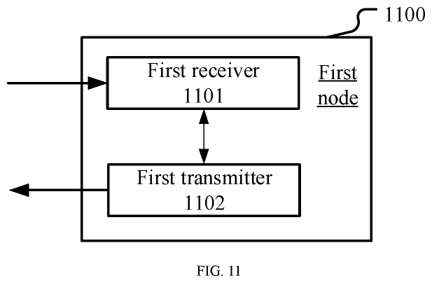

Embodiment 10 illustrates a schematic diagram of a first report being used to indicate whether a first signaling process is successfully executed according to one embodiment of the present application, as shown in FIG. 10.

In one embodiment, the first report explicitly indicates whether the first signaling process is successfully executed.

In one embodiment, the first report comprises information that the first signaling process is not successfully executed.

In one embodiment, the first report comprising information that the first signaling process is not successfully executed is used to indicate that the first signaling process is not successfully executed.

In one embodiment, the first report comprising information that the first signaling process is successfully executed is used to indicate that the first signaling process is successfully executed.

In one embodiment, the first report comprises a fourth field, and the first report comprising the fourth field is used to indicate that the first signaling process is not successfully executed.

In one embodiment, the first report comprises handover failure information.

In one embodiment, the handover failure information is specific to the first signaling process.

In one embodiment, the first signaling process is used for handover.

In one embodiment, the first signaling process not being successfully executed comprises at least the first signaling not being executed or the first signaling not being successfully executed.

In one embodiment, the first report comprises the target SpCell, and the target SpCell is a failed target SpCell.

In one embodiment, the first report comprises information of a transmitter of the first signaling.

In one subembodiment of the embodiment, information of the transmitter of the first signaling comprises an identity of the transmitter of the first signaling.

In one subembodiment of the embodiment, information of the transmitter of the first signaling comprises an identity of a source cell.

In one subembodiment of the embodiment, information of the transmitter of the first signaling comprises an identity of a previous cell.

In one embodiment, the first report comprises an identity of a previous cell.

In one embodiment, the first signaling does not comprise reconfiguraitonWithSync.

In one embodiment, the first report is used to indicate HoF.

In one embodiment, the first report comprises rlf-report.

In one embodiment, the first signaling process is L1L2 mobility process.

In one embodiment, the first signaling process is L2 mobility process.

In one embodiment, the first signaling process is L2 inter-cell mobility process.

In one embodiment, the first signaling process is L2 SpCell mobility process.

### Embodiment 11

Embodiment 11 illustrates a structure block diagram of a processor in a first node according to one embodiment of the present application, as shown in FIG. 11. In FIG. 11, a processor 1100 in a first node comprises a first receiver 1101 and a first transmitter 1102. In Embodiment 11,

the first receiver 1101 receives a first signaling; and the first signaling comprises a first cell identity, the first cell identity is configured to a target SpCell;

the first receiver 1101 detects a first event;

herein, the first event belongs to a first candidate event set, the first candidate event set comprises at least one of a first timer being expired, receiving an indication of MAC of an MCG related to a problem occurring in random access process, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling process; when there is no ongoing first signaling process, the behavior of detecting a first event triggers radio link failure; when there is an ongoing first signaling process, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a Medium Access Control (MAC) layer or control information of a physical layer; the first signaling process comprises at least one of transmitting a first signal, expecting the second signaling, receiving the second signaling, or executing the first signaling; the first signal comprises a measurement result of L1.

In one embodiment, when there is an ongoing first signaling process, the first signaling process failed to be executed successfully is used to trigger an RRC connection re-establishment.

In one embodiment, initiating the first signaling process comprises starting a second timer; a running state of the second timer is used to determine whether there is an ongoing first signaling process; when the second timer is running, there is an ongoing first signaling process; when the second timer is not running, there is no ongoing first signaling process.

In one embodiment, the first receiver 1101 receives a first indication from MAC of an MCG, the first indication is used to indicate that the first signaling process is not successfully executed, and a reception of the first indication is used to trigger radio link failure of an MCG.

In one embodiment, a first condition and whether there is an ongoing first signaling process are used together to determine whether to start a first timer; when there is an ongoing first signaling process, not start the first timer; when there is no ongoing first signaling process and the first condition is met, start the first timer; when there is no ongoing first signaling process and the first condition is not met, not start the first timer; the first condition comprises: receiving N continuous out-of-step indications from lower layer.

In one embodiment, the first transmitter 1102 transmits a first report, and the first report is used to indicate whether a first signaling process is successfully executed; the first report comprises an identity of at least the target SpCell.

In one embodiment, the first transmitter 1102 initiates an RRC connection re-establishment; the behavior of initiating an RRC re-establishment comprises executing cell selection; as a response to selecting the target SpCell, executes the first signaling.

In one embodiment, the first signal is used to trigger the second signaling.

In one embodiment, the first transmitter 1102 transmits a second report, and the second report is used to indicate that the first event is detected;

herein, there is an ongoing first signaling process.

In one embodiment, the first node is a UE.

In one embodiment, the first node is a terminal that supports large delay differences.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things terminal or an Industrial Internet of Things terminal.

In one embodiment, the first node is a device that supports transmission with low-latency and high-reliability.

In one embodiment, the first node is a sidelink communication node.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling; the first signaling comprising a first cell identity, the first cell identity being configured to a target Special Cell (SpCell); and
the first receiver, detecting a first event;
wherein the first event belongs to a first candidate event set, the first candidate event set comprises at least one of a first timer being expired, receiving an indication of Medium Access Control (MAC) of an Master Cell Group (MCG) related to a problem occurring in random access procedure, receiving an indication of Radio link Control (RLC) of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling procedure; when there is no ongoing first signaling procedure, the behavior of detecting a first event triggers radio link failure; when there is an ongoing first signaling procedure, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a MAC layer or control information of a physical layer; the first signaling procedure comprises at least one of transmitting a first signal, expecting the second signaling, receiving the second signaling, or executing the first signaling; the first signal comprises a measurement result of L1.

2. The first node according to claim 1, wherein
when there is an ongoing first signaling procedure, the first signaling procedure failed to be executed successfully is used to trigger an RRC connection re-establishment.

3. The first node according to claim 1, wherein
initiating the first signaling procedure comprises starting a second timer; a running state of the second timer is used to determine whether there is an ongoing first signaling procedure; when the second timer is running, there is an ongoing first signaling procedure; when the second timer is not running, there is no ongoing first signaling procedure.

4. The first node according to claim 2, wherein
initiating the first signaling procedure comprises starting a second timer; a running state of the second timer is used to determine whether there is an ongoing first signaling procedure; when the second timer is running, there is an ongoing first signaling procedure; when the second timer is not running, there is no ongoing first signaling procedure.

5. The first node according to claim 1, wherein
a first condition and whether there is an ongoing first signaling procedure are used together to determine whether to start a first timer; when there is an ongoing first signaling procedure, not start the first timer; when there is no ongoing first signaling procedure and the first condition is met, start the first timer; when there is no ongoing first signaling procedure and the first condition is not met, not start the first timer; the first condition comprises: receiving N continuous out-of-step indications from lower layer.

6. The first node according to claim 2, wherein
a first condition and whether there is an ongoing first signaling procedure are used together to determine whether to start a first timer; when there is an ongoing first signaling procedure, not start the first timer; when there is no ongoing first signaling procedure and the first condition is met, start the first timer; when there is no ongoing first signaling procedure and the first condition is not met, not start the first timer; the first condition comprises: receiving N continuous out-of-step indications from lower layer.

7. The first node according to claim 3, wherein
a first condition and whether there is an ongoing first signaling procedure are used together to determine whether to start a first timer; when there is an ongoing first signaling procedure, not start the first timer; when there is no ongoing first signaling procedure and the first condition is met, start the first timer; when there is no ongoing first signaling procedure and the first condition is not met, not start the first timer; the first condition comprises: receiving N continuous out-of-step indications from lower layer.

8. The first node according to claim 4, wherein
a first condition and whether there is an ongoing first signaling procedure are used together to determine whether to start a first timer; when there is an ongoing first signaling procedure, not start the first timer; when there is no ongoing first signaling procedure and the first condition is met, start the first timer; when there is no ongoing first signaling procedure and the first condition is not met, not start the first timer; the first condition comprises: receiving N continuous out-of-step indications from lower layer.

9. The first node according to claim 1, comprising:
the first transmitter, transmitting a first report, and the first report being used to indicate whether a first signaling procedure is successfully executed; the first report comprising an identity of at least the target SpCell.

10. The first node according to claim 1, comprising:
the first transmitter, initiating an RRC connection re-establishment; the behavior of initiating an RRC re-establishment comprises executing cell selection; as a response to selecting the target SpCell, executing the first signaling.

11. The first node according to claim 1, wherein
the first signal is used to trigger the second signaling.

12. The first node according to claim 1, comprising:
the first transmitter, transmitting a second report, and the second report being used to indicate that the first event is detected;
wherein there is an ongoing first signaling procedure.

13. The first node according to claim 2, comprising:
the first transmitter, transmitting a second report, and the second report being used to indicate that the first event is detected;
wherein there is an ongoing first signaling procedure.

14. The first node according to claim 3, comprising:
the first transmitter, transmitting a second report, and the second report being used to indicate that the first event is detected;
wherein there is an ongoing first signaling procedure.

15. The first node according to claim 1, comprising:
the first receiver, receiving a first indication from MAC of a MCG, the first indication being used to indicate that the first signaling procedure is not successfully executed, and a reception of the first indication being used to trigger radio link failure of an MCG.

16. The first node according to claim 1, wherein
the first signaling is comprised in an RRCReconfiguration message; and the first signaling is an RRCReconfiguration message.

17. The first node according to claim 1, wherein
the first signaling procedure is not successfully executed comprises: a timer associated with the first signaling procedure being expired.

18. The first node according to claim 17, wherein
an initiation of the first signaling procedure comprises starting a second timer; the second timer is a timer other than T304; and an expiration of the second timer triggers an RRC connection re-establishment.

19. The first node according to claim 1, wherein
a size of the first signal is 0.

20. A method in a first node for wireless communications, comprising:
receiving a first signaling; the first signaling comprising a first cell identity, the first cell identity being configured to a target SpCell; and
detecting a first event;
wherein the first event belongs to a first candidate event set, the first candidate event set comprises at least one of a first timer being expired, receiving an indication of MAC of an MCG related to a problem occurring in random access procedure, receiving an indication of RLC of an MCG related to reaching a maximum number of retransmissions, or receiving an indication of MAC of an MCG related to continuous uplink listen before talk (LBT) failure; the behavior of detecting whether a first event triggers radio link failure is related to whether there is an ongoing first signaling procedure; when there is no ongoing first signaling procedure, the behavior of detecting a first event triggers radio link failure; when there is an ongoing first signaling procedure, the behavior of detecting a first event does not trigger radio link failure; the first signaling is a Radio Resource Control (RRC) layer signaling; the first signaling comprises a first field; the first field is used to configure the target SpCell; an execution of the first signaling depends on a second signaling; the second signaling is a control signaling of a Medium Access Control (MAC) layer or control information of a physical layer; the first signaling procedure comprises at least one of transmitting a first signal, expecting the second signaling, receiving the second signaling, or executing the first signaling; the first signal comprises a measurement result of L1.
